(19) United States
(12) Patent Application Publication
(10) Pub. No.: US 2015/0375224 A1
(43) Pub. Date: Dec. 31, 2015

(54) LABORATORY FLASKS AND FLASK KITS

(71) Applicant: CHEMRUS INC., Dover, MA (US)

(72) Inventors: Xiaogao LIU, Dover, MA (US); Jianjian CAI, Dover, MA (US)

(21) Appl. No.: 14/763,341

(22) PCT Filed: Jan. 24, 2014
(86) PCT No.: PCT/US2014/013018

§ 371 Date: Jul. 24, 2015

Related U.S. Application Data
(60) Provisional application No. 61/756,129, filed on Jan. 24, 2013.

(51) Int. Cl. B01L 3/08; B01L 9/00

(52) U.S. Cl. CPC B01L 3/08; B01L 9/00; B01L 2300/0851; B01L 2300/12; B01L 2300/1894; B01L 2300/0803; B01L 2300/1805

(57) ABSTRACT

The innovative glass flasks have a standard taper outer joint to fit the most commonly used glassware in chemical laboratories. Unlike the round bottom flasks, the innovative flasks with an external flat bottom can be kept upright on the bench without the flask holder support. The flasks can be held by a corresponding shaped cooling block or heating block to perform multi-flask reactions simultaneously on a magnetic hot plate stirrer without the use of clamps at various temperatures. It also ensures that the magnetic stir bars spin consistently and efficiently on a flat or a shallow hemispherical bottom when the flasks are offset from the center of the magnetic stirrer. The flasks can also resist fracturing under vacuum for solvent distillations.

### PRIORITY CLAIM

This application claims priority to U.S. Provisional Application No. 61/756,129, filed Jan. 24, 2013, which is incorporated by reference in its entirety.

### BACKGROUND OF THE INVENTION

1. Field of the Invention

The invention relates to chemistry laboratory glassware, particularly to the innovative flasks and their kits used for multi-flask chemical reactions and solvent distillations.

2. Description of the Related Art

Laboratory flasks such as round bottom flasks, one of the most conventional glassware, are used as laboratory glassware mostly for chemical or biochemical work. The spherical flasks typically have at least a single-necked standard tapered outer joint with an opening at the tip. Because of the round bottom, the flask holders, such as cork rings, must be used to keep the flasks upright on the bench. The most common applications of round bottom flasks are to perform chemical reactions at various temperatures. When in use, the flask is commonly clamped at the neck by a clamp on a stand. When cooling is needed for a chemical reaction, the flask can be partially submerged into a cooling bath filled with a cooling agent such as ice or dry ice and, optionally, solvent mixtures. Similarly, the flask can be heated by partially submerging it into heated oil bath on an electric hot plate. In addition to chemical reactions, the round bottom flasks can be used for solvent distillations under reduced pressure because they are more resistant to fracturing under vacuum, as the sphere shape of the glass flask can more evenly distributes stress around its surface.

Although the round bottom flasks are the most commonly used glassware, they still have several deficiencies. Firstly, the flasks must be held by the cork rings to be kept upright. The use of many cork rings on the bench is inconvenient and messy. Secondly, the flask has to be clamped on a stand to run a chemical reaction. However, to set up such an apparatus using a clamp is inconvenient. Thirdly, to clamp multiple flasks on a stand is not always practical, so it is difficult to perform multi-flask chemical reactions on a magnetic hot plate stirrer. Fourthly, use of oil bath to heat flasks could spill and cause fires, and cleaning up of inevitable oil spills is inconvenient and time consuming. Thus, the innovative flasks with their kits that solve the aforementioned problems are desirable.

### SUMMARY OF THE INVENTION

The innovative glass flasks are designed to replace the existing laboratory flasks, and in particular, round bottom flasks. Like existing flasks, the innovative flasks have at least one single necked standard tapered outer joint to fit the most commonly used glassware with standard tapered inner joint in chemistry laboratories. Unlike the round bottom flasks, the innovative flasks have an outside flat bottom, which can keep themselves upright on the bench without cork ring support.

Furthermore, the innovative flasks with a barrel-shaped, taper-shaped or curved taper shaped portion can be held by corresponding shaped openings of a cooling block or heating block to perform multi-flask reactions on a magnetic hot plate stirrer simultaneously. When cooling is needed, the innovative flasks can be inserted into a cooling block, which is submerged into a cooling bath filled with a cooling agent to perform multi-flask reactions at low temperatures without the use of clamps. Similarly, heating can be accomplished by inserting the multiple innovative flasks into a heating block to perform multi-flask reactions on a magnetic hot plate stirrer without the use of clamps. The heating block is a safe alternative to oil bath. For multi-flask reactions, the flasks have to offset from the center of the magnetic hot plate stirrer. However, the magnetic stir bar with the innovative flask spins regularly and consistently. The round bottom flask can only be used for a single chemical reaction on a magnetic stirrer because its spherical body needs to be clamped on a stand.

Two commercially available flasks and bottles may appear similar to the innovative glass flasks, but they are not able to use for multi-flask reactions and solvent distillations. The first one is a flat bottom flask with single-necked standard taper outer joint. Due to its hemispherical shape, the flask must be clamped at the neck by a clamp. Also, an obvious corner between the flask wall and flat bottom may cause burst under vacuum. Furthermore, its flat bottom is purposely designed slightly convex upward with a protruding circular edge to prevent slither on the bench. This kind of flat bottom makes the magnetic stir bar spin intermittently and irregularly when the flask is offset from the center of the stirrer. The second commercially available one is a regular glass liquid storage bottle comprising a single-necked standard taper outer joint, a barrel-shaped wall, and a flat bottom. The storage bottle may burst during a solvent distillation because the 90 degree angle between the barrel-shaped wall and the flat bottom cause fracture under vacuum. Like the flat bottom flask, the bottle has slightly convex upward bottom, which allows the magnetic stir bar to spin intermittently and irregularly when it is offset from the center. All of the flat bottoms of the flasks and bottles in chemical laboratories are slightly convex upward to prevent sliding.

Other aspects, embodiments, and features will be apparent from the following description, the drawings, and the claims.

### BRIEF DESCRIPTION OF THE DRAWING

FIG. 1 is a side view of an innovative flask with a barrel-shaped middle portion according to the present invention.

FIG. 2 is a side view of an alternative innovative flask with a barrel-shaped middle portion according to the present invention.

FIG. 3 is a side view of an innovative flask with a taper-shaped lower portion according to the present invention.

FIG. 4 is a side view of an innovative flask with an oval-shaped body according to the present invention.

FIG. 5 is a perspective view of a cooling block with multiple openings according to the present invention.

FIG. 5A is a perspective view of a removable barrel-shaped flask holder according to the present invention.

FIG. 5B is a perspective view of a cooling bath having circle slots on the bottom according to the present invention.

FIG. 6 is a perspective view of a multi-flask reaction apparatus at low temperature according to the present invention.

FIG. 7 is a perspective view of a heating block with multiple openings according to the present invention.

FIG. 8 is a perspective view of a multi-flask reaction apparatus at room or high temperature according to the present invention.

### DETAILED DESCRIPTION

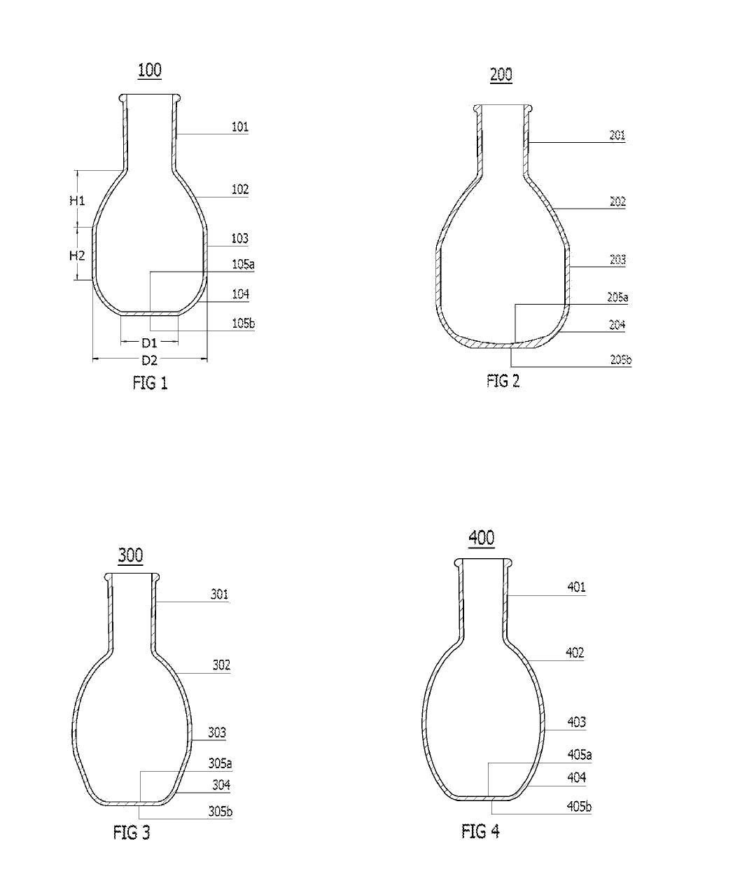

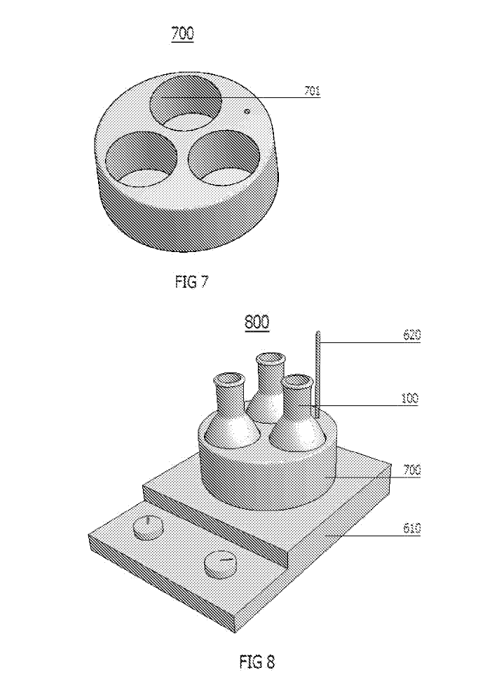

In the first embodiment shown in FIG. 1, the innovative glass flask 100 has a single-necked standard tapered outer joint 101, a upper portion 102 adjacent to the joint, a barrel-shaped middle portion 103 adjacent to the upper portion, a curved lower portion 104 adjacent to the middle portion, an inside flat bottom 105a and an outside flat bottom 105b. The standard tapered outer joint 101 is in sizes of 14/20, 19/22, 24/25, 24/40, 29/26, 29/42, 34/45, 45/50, or 55/50, which fit the most commonly used laboratory glassware with the standard tapered inner joints. While the length of the joint is listed, it will be appreciated that the length of the tapered region can vary and does not need to match the tapered joint exactly. As is conventionally known, a size of 14/20, for example, means that the standard tapered outer joint 101 is fourteen millimeters in diameter and twenty millimeters in length. The upper portion 102 is slightly curved (e.g., a larger radius of curvature than other curved portions of the flask) or tapered, so the solid samples can be easily taken out by a stainless steel lab spoon. Usually, the solid samples in a round bottom flask are difficult to be taken out completely with a lab spoon due to the curved upper portion 102. However, for multi outer joint 101 on center and side necks, the upper portion 102 can be more curved. The flask 100 with barrel-shaped middle portion 103 can be held by a cooling block 500 as shown in FIG. 6 or a heating block 700 as shown in FIG. 8 to perform multi-flask reactions without the use of clamp. The inside flat bottom 105a ensures that the magnetic stir bar spins consistently and efficiently when the flask is offset from the center of the magnetic stirrer. The outside flat bottom 105b can keep the flask upright on the bench without a cork ring support. It is understood that a large flat surface 105b can stabilize the flask 100 in standing position but may cause fracturing under vacuum. In contrast, the small flat surface resists possible fracture under vacuum but may cause the flask to become unstable in a standing position. An optimum size for surface of 105b depends on the flask stability in standing position on the bench and resistance to fracture under vacuum, which is determined by using the diameter ratio of the 105b to the 103. In general, the diameter ratio of D1/D2 should be between 0.2 and 0.8. The preferred ratio is between 0.4 and 0.6. The height of the innovative flasks also affects their standing stability because it has a lower center of gravity. The ratio of the height H2 of 103 to the external diameter D2 of 103 should be between 0.2 and 2.0, or 0.2 and 1.0. The preferred ratio is between 0.4 and 0.8. In addition, the ratio of the height H1 of the upper portion 102 to the height H2 of the barrel-shaped middle portion 103 should be between 0.4 and 2.0. The preferred ratio is between 1 and 2 or 1 and 1.4 depending on the sizes of flask 100. The upper portion 102 and lower portion 104 smoothly connect to the barrel-shaped middle portion 103. The lower portion 104 has also a smooth transition to the flat bottom 105, so the flask 100 resists fracturing under vacuum during solvent distillation. The flask 100 may have multi-necked standard taper outer joints 101 on center and side necks.

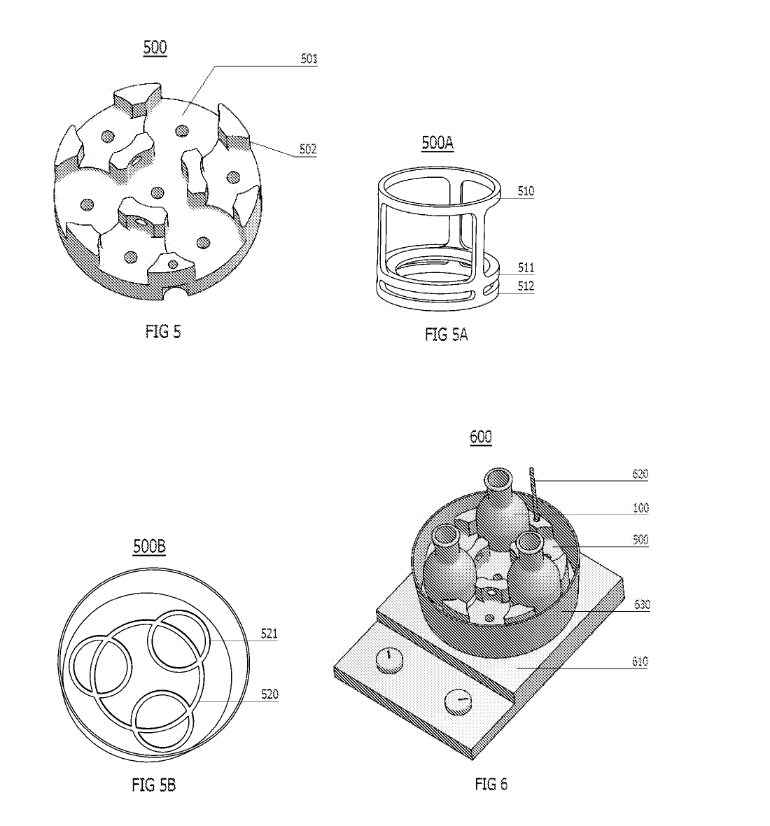

In the second embodiment shown in FIG. 2, the innovative glass flask 200 is identical to the flask 100 except its inside curved bottom 205a. The curved bottom 205a can not only more evenly distribute stress around its surface to resist fracturing under vacuum, but can also keep the magnetic stir bar to spin more consistently and regularly than the flat bottom 105a when it is offset from the center of the magnetic stirrer. The flask 200 may have multi-necked standard taper outer joints 201 on center and side necks. In the third embodiment shown in FIG. 3, the innovative glass flask 300 has a standard taper outer joint 301, a curved upper portion 302 adjacent to the joint, a taper-shaped lower portion 303 adjacent to the upper portion, a transition portion 304 adjacent to lower portion, an inside flat bottom 305a and an outside flat bottom 305b. The upper portion 302 has a smooth transition to the lower portion 303. The transition portion 304 smoothly connects lower portion 303 and flat bottom 305 to resist fracturing under vacuum. The taper-shaped lower portion 303 can be held by the taper-shaped openings of a cooling block 500, or a heating block 700 to perform multi-flask reactions without the use of clamps. The shape of the lower portion of the flask can mate with the shape of the openings of the block to secure the position of the flask. Compared to the barrel-shaped middle portion 103, the taper-shaped flask 300 can be held tightly by the heating block because they physically touch each other, so that the heat can be transferred more efficiently. The outside flat bottom 305b can keep the flask 300 upright on the bench without the use of a cork ring. The flask may have a hemispherical or shallow hemispherical bottom 305a to ensure that the stir bar spinning more consistently and efficiently when it is offset from the center of magnetic stirrer, as well as to resist more fracturing under vacuum. In the fourth embodiment shown in FIG. 4, the oval-shaped flask 400 has a standard taper outer joint 401, a curved taper-shaped upper portion 402 adjacent to the joint, a curved taper-shaped lower portion 403 adjacent to the upper portion, a transition portion 404, an inside flat bottom 405a, and an outside flat bottom 405b. The oval shaped flask 400 can be held tightly by the curved taper shaped openings of a cooling block or a heating block without the use of clamps. The outside flat bottom 405b keeps the flask upright without cork ring support. The inside bottom 405a may be hemispherical or shallow hemispherical to make the stir bar spinning more regularly and consistently. The flask 400 may have multi-necked standard taper outer joints 401 on center and side necks. All of the above innovative flasks are made of borosilicate glass to resist thermal shock.

FIG. 5 shows cooling block 500 having multiple openings 501, which fit differently shaped innovative flasks. The openings 501 with multiple side channels 502 allow the cooling agent to contact the surface of the flasks more efficiently. The flasks are inserted in the corresponding openings of the cooling block 500 and then are placed in a cooling bath 630 as shown in FIG. 6 to form a flask cooling kit, which can perform multi-flask reactions simultaneously at low temperature without the use of clamps. The cooling block 500 is made of metal, ceramic or polymer. It should be understood that the number and size of openings 501 and channels 502 are shown for exemplary purposes only. Other patterns of cooling blocks can also be desirable. FIG. 5A shows a removable barrel-shaped flask holder 500A consisting of three rings and three vertical bars, which can hold the barrel-shaped flasks 100 without a clamp to perform chemical reactions at low temperatures. The top ring 510 is slightly bigger than the barrel-shaped portion 103 to hold the flask 100. The middle ring 511 with a smaller inner bevel face restains the curved lower portion 104 of flask 100. The bottom ring 512 can be removably inserted in the center circle slot 520 or side circle slot 521 of cooling bath 500B as shown in FIG. 5B. As mentioned before, when the flask 100 in the flask holder 500A is inserted in the side circle slot 521, the magnetic stir bar becomes off center. In this situation, a suitable gap between the bottom of the flask 100 and the outside bottom of the cooling bath 500B is important to make the stir bar spin regularly and consistently. If the flask 100 is close to the bottom, the stir bar spins irregularly. On the other hand, if the flask 100 is far from the bottom, the stir bar loses the magnetic power. The preferred gap is between 1 and 4 centimeters. The flask holder 500A is made of metal, ceramic, or polymer, which should have the minimum of two skeleton vertical bars and three skeleton rings to allow at least over 30% of surface contact between the flask and cooling agent, or at least over 40% of surface contact between the flask and cooling agent. Similarly, a taper-shaped flask holder can also be used to hold the taper-shaped flask 300 without a clamp. FIG. 5B shows a cooling bath 500B having a large circle slot 520 on the bottom center and three small circle slots 521 on the bottom side, which can be removably inserted by the flask holder 500A for holding either one large flask 100 or three small flasks 100 to form an alternative flask cooling kit. The removable flask holder includes a plurality of recesses sized to fit flasks having different base dimensions, which can allow the kit to be used for various reaction volumes. The kit makes the multi-flask reactions at low temperatures become simple and flexible. It should be understood that the circle slots 520 and 521 inserted by flask holders 500A are shown for exemplary purposes only. Other similar inserting patterns of removable flask holders into cooling baths are also desirable. The cooling bath 500B is made of metal, ceramic, or polymer.

FIG. 6 shows a multi-flask reaction apparatus 600 for low temperature reactions comprising a flask cooling kit (a cooling block 500, three innovative flasks 100 with stir bars), a magnetic hot plate stirrer 610, and a thermometer 620. The apparatus is filled with a cooling agent to perform multi-flask reactions simultaneously at low temperatures without the use of clamps. The apparatus is very simple to assemble and disassemble. The heating block as shown in FIG. 7 has three openings 701 to fit different shaped innovative flasks. The heating block 700 holds the innovative flasks to form a flask heating kit. The heating block 700 is made of metal or ceramic. It should be understood that the number and size of openings 701 in the heating block 700 are shown for exemplary purposes only. FIG. 8 indicates a multi-flask reaction apparatus 800 for room or high temperature reactions comprising a flask heating kit, a magnetic hot plate stirrer 610, and a thermometer 620. The apparatus 800 can simultaneously perform multi-flask chemical reactions at room or high temperatures without the use of clamps.

A number of embodiments of the invention have been described. Nevertheless, it will be understood that various modifications may be made without departing from the spirit and scope of the invention. Accordingly, other embodiments are within the scope of the following claims.

We claim:

1. A glass flask comprising:
a standard taper outer joint having an opening;
an upper portion adjacent to the joint;
a barrel-shaped or a taper-shaped or a curved taper-shaped portion adjacent to the upper portion;
a curved transition lower portion adjacent to the barrel-shaped or taper-shaped or curved taper-shaped portion;
an internal hemispherical shaped or shallow hemispherical shaped or flat bottom;
and an external flat bottom in opposite side of the internal bottom.

2. The glass flask as recited in claim 1 wherein the flasks have the standard taper outer joints of 14/20, 19/22, 24/25, 24/40, 29/26, 29/42, 34/45, 45/50 or 55/50.

3. The glass flask as recited in claim 1 wherein the external flat bottom and the barrel-shaped middle portion has a diameter ratio between 0.2 and 0.8.

4. The glass flask as recited in claim 1, wherein the height of the middle portion to the external diameter of the middle portion has a ratio between 0.2 and 2.

5. The glass flask as recited in claim 1 wherein the upper portion to the barrel-shaped middle portion has a height ratio between 0.4 and 2.

6. The glass flask as recited in claim 1, wherein the upper portion is slightly curved or tapered for a single-necked standard taper outer joint.

7. The glass flask as recited in claim 1, wherein the flask has multi-necked standard taper outer joints on center and side necks.

8. The glass flask as recited in claim 1, wherein the flask is borosilicate glass.

9. The glass flask as recited in claim 1, wherein the boundary transition between the bottom and curved transition portion is smooth.

10. The glass flask as recited in claim 1, wherein the barrel-shaped, taper-shaped or curved taper-shaped portion are held by the cooling block or heating block for chemical reactions without the use of clamps.

11. A flask cooling kit for single or multi-flask chemical reactions at low temperature without the use of clamps comprises:
one or more of the glass flask as recited in claim 1;
a cooling block comprising one or more openings configured to hold one or more flasks;
and a cooling bath.

12. The flask cooling kit as recited in claim 11, wherein the openings have multiple side channels.

13. The flask cooling kit as recited in claim 11, wherein the openings are barrel, taper or curved taper shape.

14. The flask cooling kit as recited in claim 11, wherein the cooling block is made from metal, ceramic, or polymer.

15. A flask cooling kit for single or multi-flask chemical reactions at low temperature without the use of clamps comprising:
the glass flask as recited in claim 1;
a removable frame structured flask holder having an internal barrel-shape or taper-shape or curved taper-shape;
and a cooling bath.

16. The flask cooling kit as recited in claim 15, wherein the cooling bath includes one or more circle slots on the bottom.

17. The flask cooling kit as recited in claim 15, wherein the frame structured flask holder is configured to be removably inserted on the internal bottom of the cooling bath.

18. The flask cooling kit as recited in claim 15, wherein the removable frame structured flask holder includes rings that allow the flask to have at least 30% surface contact with the cooling agent.

19. The flask cooling kit as recited in claim 15, wherein the removable flask holder has a middle ring configured to support the flask.

20. The flask cooling kit as recited in claim 19, wherein the removable flask holder has a gap from the flask bottom to the external bottom of cooling bath between 1 and 4 centimeters.

21. The flask cooling kit as recited in claim 15, wherein the removable flask holder and cooling bath are, independently, made from metal , ceramic, or polymer.

22. The flask cooling kit as recited in claim 15, wherein the removable flask holder includes a plurality of recesses sized to fit flasks having different base dimensions.

23. A flask heating kit used for single or multi-flask chemical reactions at room or high temperature without the use of clamps comprising:
one or more flasks, at least one flask being as recited in claim 1;
and a heating block comprising one or more openings configured to hold the flask.

24. The heating block as recited in claim 23, wherein the opening is a barrel, taper or curved tape shape.

25. The flask heating kit as recited in claim 23, wherein the heating block is made from metal or ceramic.
